(19) United States
(12) Patent Application Publication
(10) Pub. No.: US 2007/0008265 A1
(43) Pub. Date: Jan. 11, 2007

(54) Driver circuit, electro-optical device, and electronic instrument

(75) Inventor: Katsuhiko Maki, Chino-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/453,057

(22) Filed: Jun. 15, 2006

(30) Foreign Application Priority Data
Jul. 7, 2005 (JP) 2005-199166

(51) Int. Cl. G09G 3/36

(52) U.S. Cl. 345/89

(57) ABSTRACT

A driver circuit includes first and second color component first and second grayscale signal line groups which extend in a first direction and to which grayscale voltages are supplied, first and second voltage select circuits which output the grayscale voltages corresponding to first and second grayscale data from the grayscale voltages supplied to the first and second grayscale signal line groups, and first and second output circuits which drive data lines based on the grayscale voltages output from the first and second voltage select circuits. The first and second voltage select circuits are disposed to be adjacent in the first direction in an upper layer or a lower layer of the second grayscale signal line group, and the grayscale voltages supplied to the first grayscale signal line group are supplied to the first voltage select circuit through interconnects extending in a second direction which intersects the first direction.

Japanese Patent Application No. 2005-199166 filed on Jul. 7, 2005, is hereby incorporated by reference in its entirety.

### BACKGROUND OF THE INVENTION

The present invention relates to a driver circuit, an electro-optical device, and an electronic instrument.

As a liquid crystal panel (electro-optical device) used for an electronic instrument such as a portable telephone, a simple matrix type liquid crystal panel and an active matrix type liquid crystal panel using a switching device such as a thin film transistor (hereinafter abbreviated as “TFT”) have been known.

The simple matrix type liquid crystal panel allows power consumption to be easily reduced in comparison with the active matrix type liquid crystal panel. However, the simple matrix type liquid crystal panel has disadvantages in that it is difficult to increase the number of colors and to display a video image. The active matrix type liquid crystal panel is suitable for increasing the number of colors and displaying a video image. However, the active matrix type liquid crystal panel has a disadvantage in that it is difficult to reduce power consumption.

In recent years, a video image display of an increased number of colors has been increasingly demanded for a portable electronic instrument such as a portable telephone in order to provide a high-quality image. Therefore, the active matrix type liquid crystal panel has been increasingly used instead of the simple matrix type liquid crystal panel.

In general, a drive signal for displaying an image is gamma-corrected corresponding to the grayscale characteristics of a display device. Taking a liquid crystal device as an example, a grayscale voltage (drive signal in a broad sense) gamma-corrected so that an optimum pixel transmissivity is realized is output based on grayscale data for performing a grayscale display. A data line is driven based on the grayscale voltage.

In order to further improve the image quality, gamma correction must be performed corresponding to each color component. Therefore, it is necessary to realize two or more types of gamma correction.

As disclosed in JP-A-2001-290457, when outputting voltages obtained by dividing a voltage in a specific range using resistor elements as the grayscale voltages, gamma correction can be realized by selectively outputting the grayscale voltage corresponding to the grayscale data from the voltages divided and corrected corresponding to the grayscale characteristics, for example.

However, a circuit which realizes such a gamma correction increases the layout area of a driver circuit which drives data lines of a liquid crystal panel, thereby resulting in an increase in cost. Moreover, it becomes impossible to satisfy a demand for a decrease in the size of the frame.

### SUMMARY

A first aspect of the invention relates to a driver circuit for driving data lines of an electro-optical device, the driver circuit comprising:

a first color component first grayscale signal line group and a second color component second grayscale signal line group, each of the first grayscale signal line group and the second grayscale signal line group extending in a first direction and including grayscale signal lines to which grayscale voltages corresponding to grayscale data are supplied;

a first voltage select circuit which outputs the grayscale voltage corresponding to first grayscale data from the grayscale voltages supplied to the grayscale signal lines of the first grayscale signal line group;

a second voltage select circuit which outputs the grayscale voltage corresponding to second grayscale data from the grayscale voltages supplied to the grayscale signal lines of the second grayscale signal line group; and

first and second output circuits which drive the data lines based on the grayscale voltages output from the first and second voltage select circuits;

the first and second voltage select circuits being disposed to be adjacent in the first direction in an upper layer or a lower layer of the second grayscale signal line group; and

the grayscale voltages supplied to the first grayscale signal line group being supplied to the first voltage select circuit through a plurality of interconnects extending in a second direction which intersects the first direction.

A second aspect of the invention relates to a driver circuit for driving data lines of an electro-optical device, the driver circuit comprising:

a first color component first grayscale signal line group and a second color component second grayscale signal line group, each of the first grayscale signal line group and the second grayscale signal line group extending in a first direction and including grayscale signal lines to which grayscale voltages corresponding to grayscale data are supplied;

a plurality of first voltage select circuits, each of the first voltage select circuits outputting the grayscale voltage corresponding to the grayscale data from the grayscale voltages supplied to the grayscale signal lines of the first grayscale signal line group;

a second voltage select circuit which outputs the grayscale voltage corresponding to the grayscale data from the grayscale voltages supplied to the grayscale signal lines of the second grayscale signal line group;

a plurality of first output circuits which drive the data lines based on the grayscale voltages output from the first voltage select circuits; and

a second output circuit which drives the data line based on the grayscale voltage output from the second voltage select circuit;

the first voltage select circuits being disposed to be adjacent in the first direction;

the second voltage select circuit being disposed to be adjacent to the first voltage select circuits in the first direction;

the first voltage select circuits and the second voltage select circuit being provided in an upper layer or a lower layer of the second grayscale signal line group; and

the grayscale voltages supplied to the first grayscale signal line group being supplied to the first voltage select circuits through a plurality of interconnects extending in a second direction which intersects the first direction and used by the first voltage select circuits.

A fourth aspect of the invention relates to an electro-optical device comprising:

a plurality of scan lines;

a plurality of data lines;

a plurality of pixels;

a scan line driver circuit which scans the scan lines; and

the above driver circuit which drives the data lines.

A fifth aspect of the invention relates to an electronic instrument comprising the above electro-optical device.

### BRIEF DESCRIPTION OF THE SEVERAL VIEWS OF THE DRAWING

FIG. 1 is a diagram showing an outline of a configuration of a liquid crystal display device according to one embodiment of the invention.

FIG. 2 is a diagram showing an outline of another configuration of a liquid crystal display device according to one embodiment of the invention.

FIG. 3 is a block diagram of a configuration example of a gate driver shown in FIG. 1.

FIG. 4 is a block diagram of a configuration example of a data driver shown in FIG. 1.

FIG. 5 is a diagram of a configuration example of a grayscale voltage generation circuit, a DAC, and a driver section according to a comparative example.

FIGS. 6A and 6B are diagrams illustrative of a configuration example of a first voltage select circuit.

FIG. 7 is a diagram of a configuration example of a grayscale voltage generation circuit, a DAC, and a driver section according to one embodiment of the invention.

FIG. 8 is a diagram of a configuration example of a grayscale voltage generation circuit, a DAC, and a driver section according to a first configuration example.

FIG. 9 is a schematic layout plan view of FIG. 8.

FIG. 10 is a diagram illustrative of interconnect layers shown in FIG. 9.

FIG. 11 is a schematic layout plan view showing the relationship among first and second grayscale signal line groups and voltage select circuits according to a second configuration example.

FIG. 12 is a diagram showing the relationship among voltage select circuits and output circuits according to the second configuration example.

FIGS. 13A and 13B are diagrams showing the relationship among voltage select circuits and output circuits when K is “2”.

FIG. 14 is a diagram of a configuration example of a grayscale voltage generation circuit, a DAC, and a driver section according to the second configuration example.

FIG. 15 is a block diagram of a data driver according to a third configuration example.

FIG. 16 is a diagram of a configuration example of a grayscale voltage generation circuit, a DAC, and a driver section according to the third configuration example.

FIGS. 17A and 17B are timing diagrams of operation examples of an address control circuit shown in FIG. 15.

FIG. 18 is a diagram showing the relationship among voltage select circuits and grayscale signal line groups according to a fourth configuration example.

FIG. 19 is a diagram of a configuration example of a grayscale voltage generation circuit, a DAC, and a driver section according to the fourth configuration example.

FIG. 20 is a block diagram of a configuration example of an electronic instrument according to one embodiment of the invention.

### DETAILED DESCRIPTION OF THE EMBODIMENT

The invention may provide a driver circuit which realizes two or more types of gamma correction without increasing the layout area, an electro-optical device, and an electronic instrument.

One embodiment of the invention relates to a driver circuit for driving data lines of an electro-optical device, the driver circuit comprising:
a first color component first grayscale signal line group and a second color component second grayscale signal line group, each of the first grayscale signal line group and the second grayscale signal line group extending in a first direction and including grayscale signal lines to which grayscale voltages corresponding to grayscale data are supplied;

a first voltage select circuit which outputs the grayscale voltage corresponding to first grayscale data from the grayscale voltages supplied to the grayscale signal lines of the first grayscale signal line group;

a second voltage select circuit which outputs the grayscale voltage corresponding to second grayscale data from the grayscale voltages supplied to the grayscale signal lines of the second grayscale signal line group; and

first and second output circuits which drive the data lines based on the grayscale voltages output from the first and second voltage select circuits;

the first and second voltage select circuits being disposed to be adjacent in the first direction in an upper layer or a lower layer of the second grayscale signal line group; and

the grayscale voltages supplied to the first grayscale signal line group being supplied to the first voltage select circuit through a plurality of interconnects extending in a second direction which intersects the first direction.

According to this embodiment, the first and second grayscale signal line groups are disposed in parallel to extend in the first direction. The first voltage select circuit to which the grayscale voltages are supplied from the first grayscale signal line group and the second voltage select circuit to which the grayscale voltages are supplied from the second grayscale signal line group are disposed to be adjacent in the first direction in the upper layer or the lower layer of the second grayscale signal line group. Therefore, the grayscale voltages can be directly supplied to the second voltage select circuit from the second grayscale signal line group in the upper layer or the lower layer through contacts. On the other hand, the grayscale voltages supplied to the first grayscale signal line group are supplied to the first voltage select circuit through the interconnects extending in the second direction which intersects the first direction.

This allows provision of a driver circuit which drives data lines of an electro-optical device based on grayscale voltages subjected to at least two types of gamma correction while reducing the layout area. Specifically, a driver circuit which can reduce cost and display a high-definition image can be provided.

In the driver circuit according to this embodiment, the first and second output circuits may be provided in an upper layer or a lower layer of the first grayscale signal line group.

According to this embodiment, since the layout area of the region in which the output circuit is disposed can be reduced, a driver circuit which can further reduce cost can be provided.

Another embodiment of the invention relates to a driver circuit for driving data lines of an electro-optical device, the driver circuit comprising:

a first color component first grayscale signal line group and a second color component second grayscale signal line group, each of the first grayscale signal line group and the second grayscale signal line group extending in a first direction and including grayscale signal lines to which grayscale voltages corresponding to grayscale data are supplied;

a plurality of first voltage select circuits, each of the first voltage select circuits outputting the grayscale voltage corresponding to the grayscale data from the grayscale voltages supplied to the grayscale signal lines of the first grayscale signal line group;

a second voltage select circuit which outputs the grayscale voltage corresponding to the grayscale data from the grayscale voltages supplied to the grayscale signal lines of the second grayscale signal line group;

a plurality of first output circuits which drive the data lines based on the grayscale voltages output from the first voltage select circuits; and

a second output circuit which drives the data line based on the grayscale voltage output from the second voltage select circuit;

the first voltage select circuits being disposed to be adjacent in the first direction;

the second voltage select circuit being disposed to be adjacent to the first voltage select circuits in the first direction;

the first voltage select circuits and the second voltage select circuit being provided in an upper layer or a lower layer of the second grayscale signal line group; and

the grayscale voltages supplied to the first grayscale signal line group being supplied to the first voltage select circuits through a plurality of interconnects extending in a second direction which intersects the first direction and used by the first voltage select circuits.

According to this embodiment, the first and second grayscale signal line groups are disposed in parallel to extend in the first direction. The first voltage select circuit to which the grayscale voltages are supplied from the first grayscale signal line group and the second voltage select circuit to which the grayscale voltages are supplied from the second grayscale signal line group are disposed to be adjacent in the first direction in the upper layer or the lower layer of the second grayscale signal line group. Therefore, the grayscale voltages can be directly supplied to the second voltage select circuit from the second grayscale signal line group in the upper layer or the lower layer through contacts. On the other hand, the grayscale voltages supplied to the first grayscale signal line group are supplied to the first voltage select circuit through the interconnects extending in the second direction which intersects the first direction.

In this case, it is desirable that the interconnect region of the interconnects extending in the second direction have a width in the first direction smaller than the width of the first voltage select circuit in the first direction. However, since the number of grayscale signal lines of the first grayscale signal line group tends to be increased due to an increase in the number of grayscales, it is difficult to reduce the width in the first direction of the interconnect region of the interconnects extending in the second direction in comparison with the width of the first voltage select circuit in the first direction. Therefore, the interconnect region of the interconnects extending in the second direction is increased, whereby the layout becomes difficult.

To deal with this problem, in this embodiment, the first color component first voltage select circuits are disposed to be adjacent in the first direction in the upper layer or the lower layer of the second grayscale signal line group. This allows the interconnects extending from the first grayscale signal line group in the second direction to be used by the first voltage select circuits. Therefore, the interconnect region of the interconnects can be substantially increased.

This allows provision of a driver circuit which drives data lines of an electro-optical device based on grayscale voltages subjected to two types of gamma correction while reducing the layout area. Specifically, a driver circuit which can reduce cost and display a high-definition image can be provided. Moreover, an increase in the interconnect region of the interconnects extending from the first grayscale signal line group in the second direction can be prevented.

In the driver circuit according to this embodiment, the grayscale voltages supplied to the second grayscale signal line group may be used as grayscale voltages for two or more color components other than the first color component.

According to this embodiment, a driver circuit can be provided which can display a high-definition image using grayscale voltages subjected to at least two types of gamma correction with a reduced layout area.

The driver circuit according to this embodiment may comprise: a third color component third grayscale signal line group extending in the first direction and including grayscale signal lines to which the grayscale voltages corresponding to the grayscale data are supplied; a third voltage select circuit which outputs the grayscale voltage corresponding to the grayscale data from the grayscale voltages supplied to the grayscale signal lines of the third grayscale signal line group; and a third output circuit which drives the data line based on the grayscale voltage output from the third voltage select circuit; wherein the third voltage select circuit may be disposed to be adjacent to the first voltage select circuits or the second voltage select circuit in the first direction in the upper layer or the lower layer of the second grayscale signal line group; and wherein the grayscale voltages supplied to the third grayscale signal line group may be supplied to the third voltage select circuit through a plurality of interconnects extending in a third direction opposite to the second direction.

According to this embodiment, since the third grayscale signal line group is further provided, an increase in the layout area of the voltage select circuit for each color component and the grayscale signal line group for each color component can be prevented even when driving the data lines using the grayscale voltages subjected to at least three types of gamma correction.

In the driver circuit according to this embodiment, the first to third output circuits may be provided in an upper layer or a lower layer of the first grayscale signal line group.

According to this embodiment, since the layout area of the region in which the output circuit is disposed can be reduced, a driver circuit which can further reduce cost can be provided.

The driver circuit according to this embodiment may comprise: a grayscale data latch in which the grayscale data corresponding to each of the voltage select circuits is held in dot units; wherein the grayscale data of each dot, which is supplied in pixel units in an order of a specific dot arrangement and rearranged in an order of an arrangement of the voltage select circuits arranged in the first direction, may be held in the grayscale data latch; and wherein the grayscale data of each dot held in the grayscale data latch may be supplied to each of the voltage select circuits through grayscale data supply lines provided not to intersect.

The driver circuit according to this embodiment may comprise: a grayscale data memory including a plurality of memory cells provided corresponding to the voltage select circuits; wherein the grayscale data of each dot, which is supplied in pixel units in an order of a specific dot arrangement and rearranged in an order of an arrangement of the voltage select circuits arranged in the first direction, may be held in each of the memory cells.

The driver circuit according to this embodiment may comprise: a write control circuit which controls writing of the grayscale data into the grayscale data memory; wherein the write control circuit may designate addresses of the memory cells corresponding to the arrangement of the voltage select circuits arranged in the first direction, and may write the grayscale data of each dot supplied in pixel units in the order of the specific dot arrangement into the memory cells corresponding to the addresses.

According to the above embodiment, since the grayscale data can be supplied to each voltage select circuit from the grayscale data latch or the grayscale data memory through the grayscale data supply lines which do not intersect, an increase in the layout area of the grayscale data supply lines can be prevented.

Another embodiment of the invention relates to an electro-optical device comprising:

a plurality of scan lines;

a plurality of data lines;

a plurality of pixels;

a scan line driver circuit which scans the scan lines; and

the above driver circuit which drives the data lines.

According to this embodiment, an electro-optical device can be provided which includes a driver circuit which realizes two or more types of gamma correction without increasing the layout area.

A further embodiment of the invention relates to an electronic instrument comprising the above electro-optical device.

According to this embodiment, an electronic instrument can be provided to which an electro-optical device including a driver circuit, which realizes two or more types of gamma correction without increasing the layout area, is applied.

The embodiments of the invention are described below in detail with reference to the drawings. Note that the embodiments described below do not in any way limit the scope of the invention laid out in the claims. Note that all elements of the embodiments described below should not necessarily be taken as essential requirements for the invention.

1. Liquid Crystal Display Device

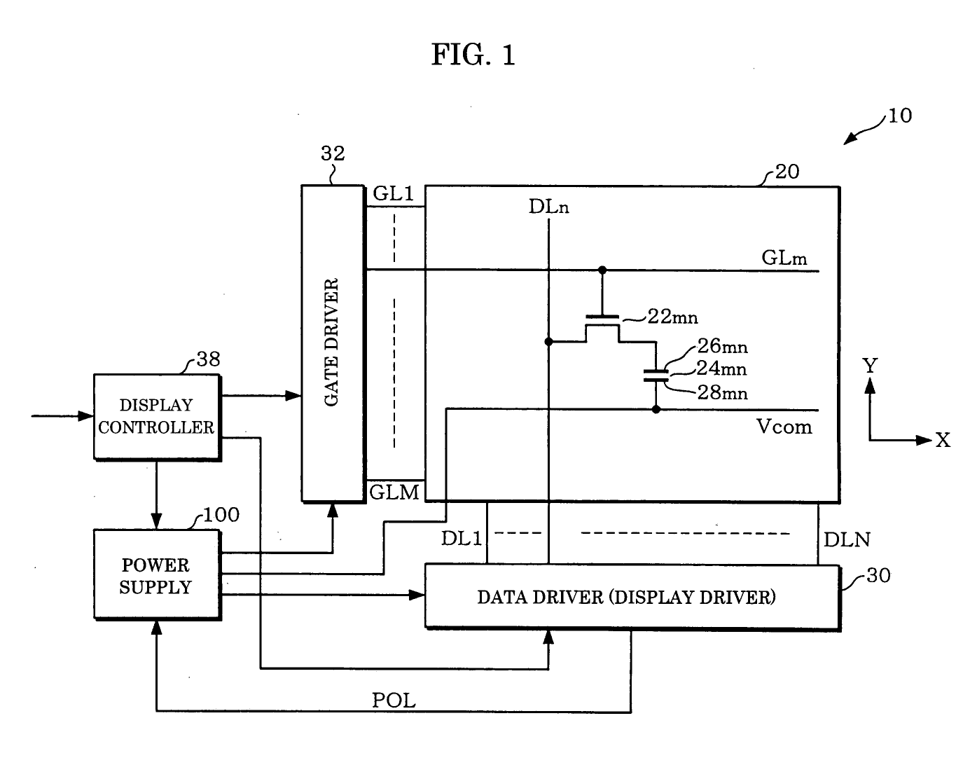

FIG. 1 shows an outline of a configuration of an active matrix type liquid crystal display device according to one embodiment of the invention. Note that a data driver (display driver in a broad sense; driver circuit in a broader sense) including a voltage select circuit according to this embodiment may be applied to a simple matrix type liquid crystal display device instead of the active matrix type liquid crystal display device.

A liquid crystal display device 10 includes a liquid crystal display (LCD) panel (display panel in a broad sense; electro-optical device in a broader sense) 20. The LCD panel 20 is formed on a glass substrate or the like. A plurality of scan lines (gate lines) GL1 to GLM (M is an integer of two or more), arranged in a direction Y and extending in a direction X, and a plurality of data lines (source lines) DL1 to DLN (N is an integer of two or more), arranged in the direction X and extending in the direction Y, are disposed on the glass substrate. A pixel area (pixel) is formed corresponding to the intersecting point of the scan line GLm (1≦m≦M, m is an integer; hereinafter the same) and the data line DLn (1≦n≦N, n is an integer; hereinafter the same). A thin film transistor (hereinafter abbreviated as “TFT”) 22mn is disposed in the pixel area.

The gate of the TFT 22mn is connected with the scan line GLn. The source of the TFT 22mn is connected with the data line DLn. The drain of the TFT 22mn is connected with a pixel electrode 26mn. A liquid crystal is sealed between the pixel electrode 26mn and a common electrode 28mn which faces the pixel electrode 26mn so that a liquid crystal capacitor (liquid crystal element in a broad sense) 24mn is formed. The transmissivity of the pixel changes corresponding to the voltage applied between the pixel electrode 26mn and the common electrode 28mn. A common electrode voltage Vcom is supplied to the common electrode 28mn.

The LCD panel 20 is formed by attaching a first substrate on which the pixel electrode and the TFT are formed to a second substrate on which the common electrode is formed, and sealing a liquid crystal as an electro-optical material between the substrates, for example.

The liquid crystal display device 10 includes a data driver (display driver in a broad sense; driver circuit in a broader sense) 30. The data driver 30 drives the data lines DL1 to DLN of the LCD panel 20 based on grayscale data.

The liquid crystal display device 10 may include a gate driver (scan driver in a broad sense) 32. The gate driver 32 scans the scan lines GL1 to GLM of the LCD panel 20 within one vertical scan period.

The liquid crystal display device 10 may include a power supply circuit 100. The power supply circuit 100 generates voltages necessary for driving the data lines, and supplies the generated voltages to the data driver 30. The power supply circuit 100 generates power supply voltages VDDH and VSSH necessary for the data driver 30 to drive the data lines and voltages for a logic section of the data driver 30, for example.

The power supply circuit 100 also generates a voltage necessary for scanning the scan lines, and supplies the generated voltage to the gate driver 32.

The power supply circuit 100 also generates the common electrode voltage Vcom. The power supply circuit 100 outputs to the common electrode of the LCD panel 20 the common electrode voltage Vcom which periodically changes between a high-potential-side voltage VCOMH and a low-potential-side voltage VCOML in synchronization with the timing of a polarity reversal signal POL generated by the data driver 30.

The liquid crystal display device 10 may include a display controller 38. The display controller 38 controls the data driver 30, the gate driver 32, and the power supply circuit 100 according to information provided by a host such as a central processing unit (hereinafter abbreviated as “CPU”) (not shown). For example, the display controller 38 sets the operation mode of the data driver 30 and the gate driver 32 and supplies a vertical synchronization signal and a horizontal synchronization signal generated therein to the data driver 30 and the gate driver 32. In this embodiment, the display controller 38 supplies gamma correction data to the data driver 30 so that various types of gamma correction can be realized.

In FIG. 1, the liquid crystal display device 10 is configured to include the power supply circuit 100 and the display controller 38. Note that at least one of the power supply circuit 100 and the display controller 38 may be provided outside the liquid crystal display device 10. Or, the liquid crystal display device 10 may be configured to include the host.

The data driver 30 may include at least one of the gate driver 32 and the power supply circuit 100.

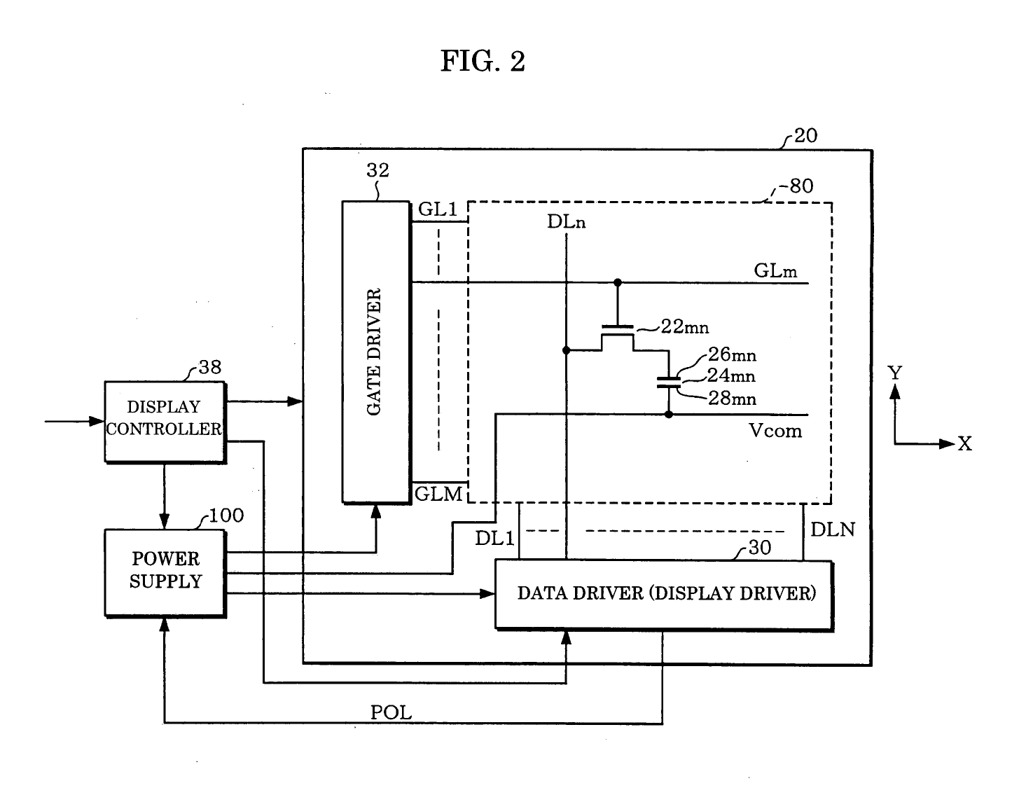

Some or all of the data driver 30, the gate driver 32, the display controller 38, and the power supply circuit 100 may be formed on the LCD panel 20. In FIG. 2, the data driver 30 and the gate driver 32 are formed on the LCD panel 20. Specifically, the LCD panel 20 may be configured to include a plurality of data lines, a plurality of scan lines, a plurality of switch devices, each of which is connected with one of the scan lines and one of the data lines, and a display driver which drives the data lines. A plurality of pixels are formed in a pixel formation area 80 of the LCD panel 20.

2. Gate Driver

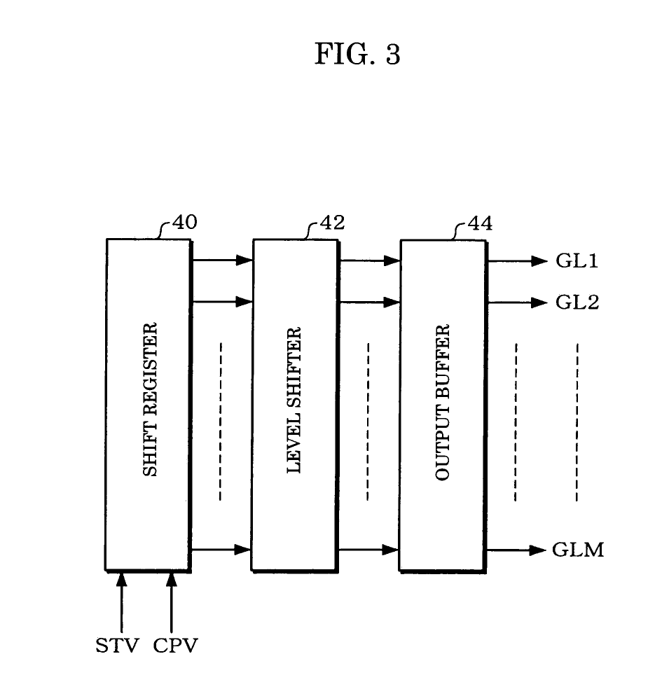

FIG. 3 shows a configuration example of the gate driver 32 shown in FIG. 1.

The gate driver 32 includes a shift register 40, a level shifter 42, and an output buffer 44.

The shift register 40 includes a plurality of flip-flops provided corresponding to the scan lines and sequentially connected. The shift register 40 holds a start pulse signal STV in the flip-flop in synchronization with a clock signal CPV, and sequentially shifts the start pulse signal STV to the adjacent flip-flops in synchronization with the clock signal CPV. The clock signal CPV is a horizontal synchronization signal, and the start pulse signal STV is a vertical synchronization signal.

The level shifter 42 shifts the level of the voltage from the shift register 40 to the voltage level corresponding to the liquid crystal element of the LCD panel 20 and the transistor performance of the TFT. As the voltage level, a high voltage level of 20 to 50 V is necessary, for example.

The output buffer 44 buffers the scan voltage shifted by the level shifter 42 and outputs the scan voltage to the scan line to drive the scan line.

3. Data Driver (Driver Circuit)

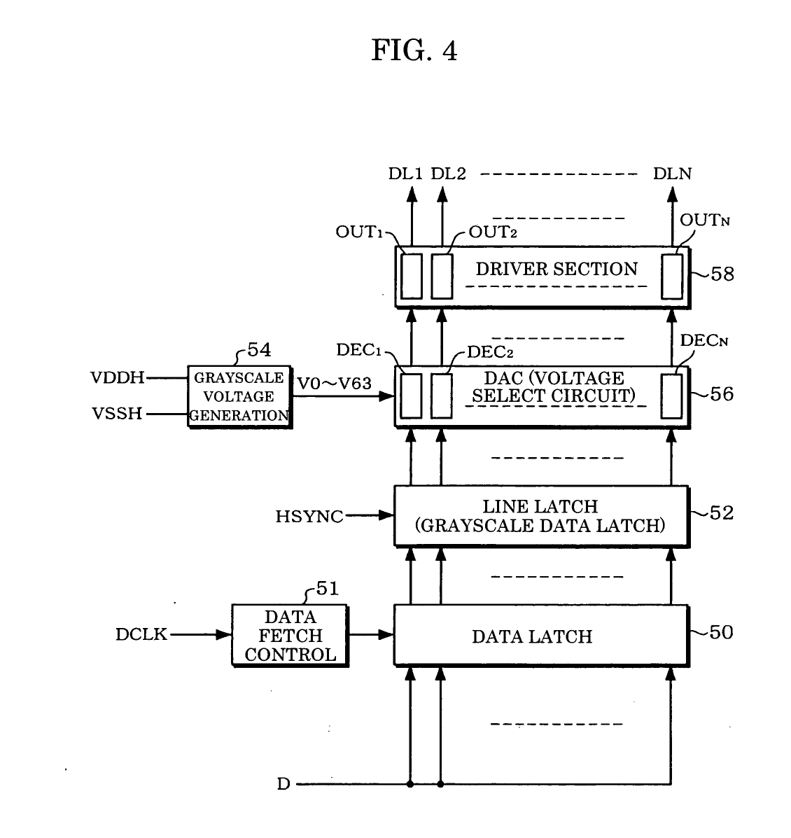

FIG. 4 is a block diagram of a configuration example of the data driver 30 shown in FIG. 1. In FIG. 4, the number of bits of grayscale data per dot is six. Note that the number of bits of grayscale data is not limited to six.

The data driver 30 includes a data latch 50, a data fetch control circuit 51, a line latch (grayscale data latch in a broad sense) 52, a grayscale voltage generation circuit 54, a digital/analog converter (DAC) 56, and a driver circuit 58.

Grayscale data is serially input to the data driver 30 in pixel units (or dot units). The grayscale data is input in synchronization with a dot clock signal DCLK. The dot clock signal DCLK is supplied from the display controller 38.

The data latch 50 includes a plurality of registers, each of which holds the grayscale data of one dot. The grayscale data of each dot is written into the register specified by the data fetch control circuit 51. The data fetch control circuit 51 writes the grayscale data of each dot into one of the registers of the data latch 50 based on the dot clock signal DCLK. For example, when each register has an address, the data fetch control circuit 51 updates the address based on the dot clock signal DCLK and writes the grayscale data into the register corresponding to the updated address. The data latch 50 thus latches the grayscale data for one horizontal scan, for example.

The line latch (grayscale data latch) 52 latches the grayscale data for one horizontal scan latched by the data latch 50 at the change timing of a horizontal synchronization signal HSYNC. The line latch 52 includes a plurality of registers, each of which holds the grayscale data of one dot. The grayscale data held in each register of the data latch 50 is written into each register of the line latch 52.

The grayscale voltage generation circuit 54 generates a plurality of grayscale voltages, each of which corresponds to each piece of grayscale data. In more detail, the grayscale voltage generation circuit 54 generates grayscale voltages V0 to V63, each of which corresponds to each piece of six-bit grayscale data, based on a high-potential-side power supply voltage VDDH and a low-potential-side power supply voltage VSSH. The grayscale voltage generation circuit 54 outputs the voltages of division nodes of a resistor circuit, to which the high-potential-side power supply voltage VDDH and the low-potential-side power supply voltage VSSH are supplied at either end, as the grayscale voltages. For example, 254 division nodes are provided in the resistor circuit, and 62 division nodes are selected from the 254 division nodes based on the gamma correction data from the display controller 38, whereby the grayscale voltages which are changed based on the gamma correction data can be output.

The DAC 56 generates the grayscale voltages corresponding to the grayscale data output from the line latch 52 in units of output lines which are outputs of the driver section 58. In more detail, the DAC 56 selects the grayscale voltage corresponding to the grayscale data of one output line of the driver section 58 output from the line latch 52 from the grayscale voltages V0 to V63 generated by the grayscale voltage generation circuit 54, and outputs the selected grayscale voltage.

The DAC 56 includes voltage select circuits DEC₁ to DEC_{N} provided in output line units. The voltage select circuit outputs one of the grayscale voltages V0 to V63 corresponding to the grayscale data.

The driver circuit 58 drives the output lines connected with the data lines of the LCD panel 20. In more detail, the driver circuit 58 drives the output lines based on the grayscale voltages output from the voltage select circuits of the DAC 56 in output line units. The driver section 58 includes output circuits OUT₁ to OUT_{N} provided in output line units. The output circuit drives the data line based on the grayscale voltage from the voltage select circuit. The output circuit may be formed by a voltage-follower-connected operational amplifier, a CMOS buffer circuit, or the like.

3.1 Grayscale Voltage Generation Circuit, DAC, and Driver Section

A configuration of a comparative example of this embodiment is described below before describing this embodiment.

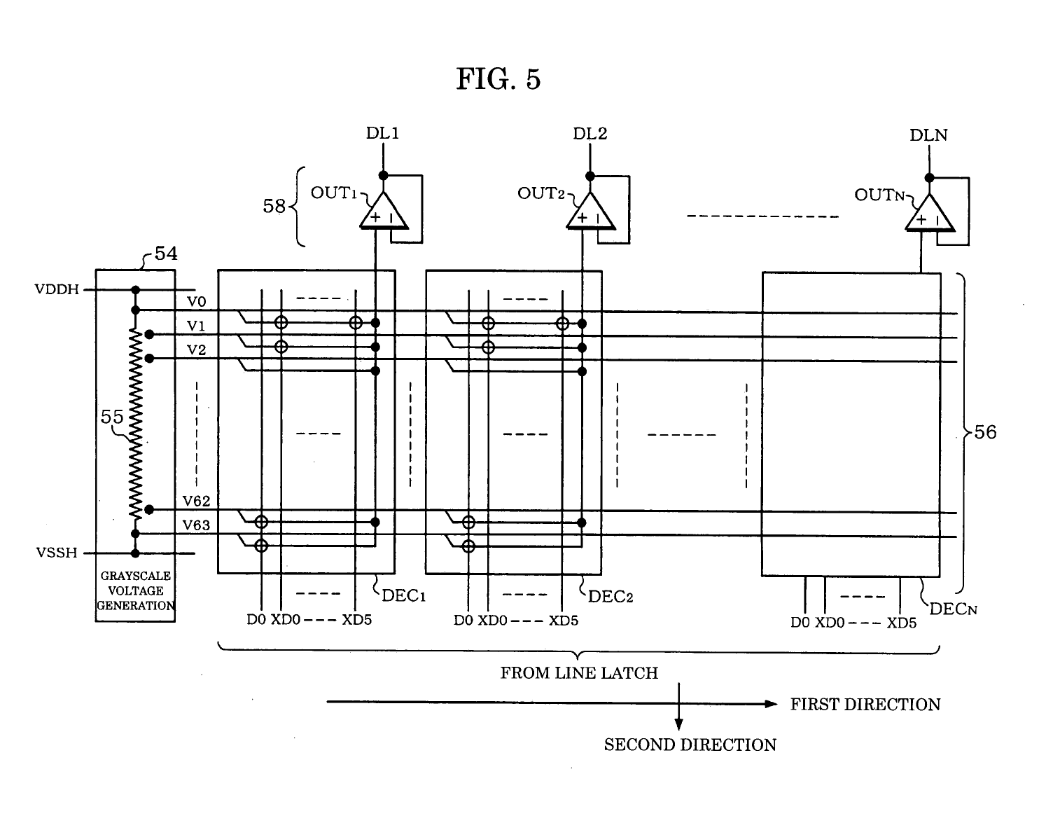

FIG. 5 is a block diagram of a configuration example of the grayscale voltage generation circuit 54, the DAC 56, and the driver section 58 according to the comparative example of this embodiment. In FIG. 5, the same sections as shown in FIG. 4 are indicated by the same symbols. Description of these sections is appropriately omitted.

The grayscale voltage generation circuit 54 includes a resistor circuit 55. The high-potential-side power supply voltage VDDH and the low-potential-side power supply voltage VSSH are supplied to either end of the resistor circuit 55. The resistor circuit 55 includes a plurality of division nodes for outputting voltages obtained by dividing the voltage across the ends using resistors, and outputs the voltage of each division node as the grayscale voltage. The gamma-corrected grayscale voltages can be output by changing the voltages obtained by division using resistors. The grayscale voltage generation circuit 54 outputs the grayscale voltages V0 to V63 obtained as described above.

In FIG. 5, the grayscale voltages V0 to V63 are supplied to grayscale signal lines of a grayscale signal line group. The grayscale signal line group is connected with the voltage select circuits DEC₁ to DEC_{N}. The voltage select circuits DEC₁ to DEC_{N} have an identical configuration. Six-bit grayscale data D0 to D5 and inversion data XD0 to XD5 of each bit are input to the voltage select circuit from the line latch 52. The voltage select circuit outputs one of the grayscale voltages V0 to V63 to the output circuit corresponding to the grayscale data D0 to D5 and the inversion data XD0 to XD5. The voltage select circuit DECⱼ (1≦j≦N, j is an integer) receives the grayscale data from the line latch 52, and supplies the grayscale voltage to the output circuit OUTⱼ. The grayscale signal line group extends in a first direction which is the direction in which the data lines are arranged.

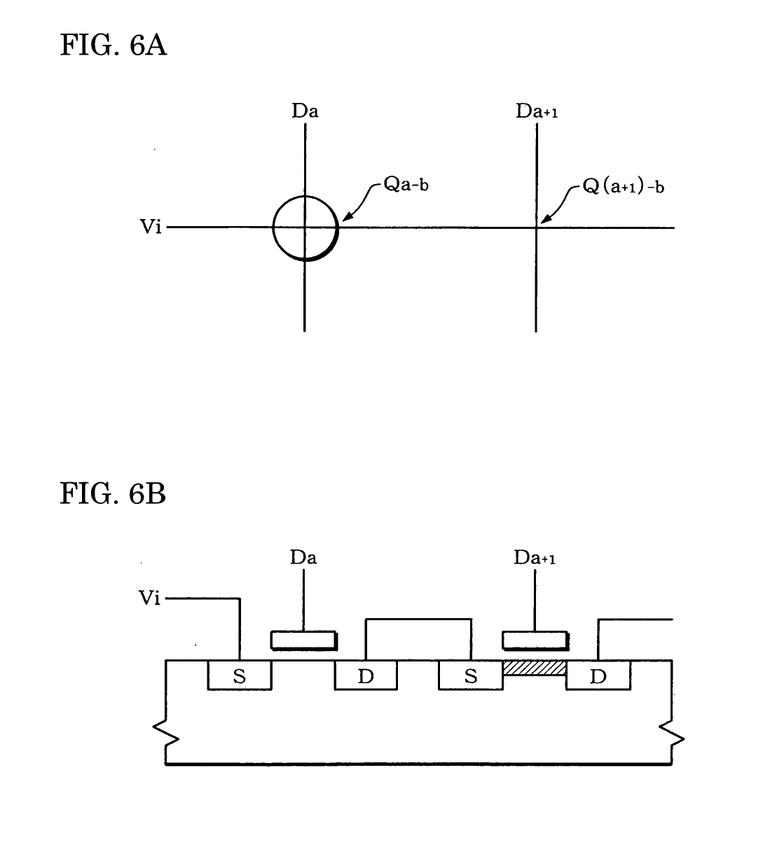

FIGS. 6A and 6B are diagrams illustrative of a configuration example of the voltage select circuit DEC₁.

FIG. 6A shows an example in which the voltage select circuit DEC₁ as the first voltage select circuit is formed by a read only memory (ROM). In this case, as shown in FIG. 6B, a transistor Qa-b is provided at the intersecting point of a grayscale signal line GVLi to which a grayscale voltage Vi is supplied and a data line Da for one bit of the grayscale data.

A transistor Q(a+1)-b is also provided at the intersecting point of the grayscale voltage signal line GVLi and a data line Da+1 for one bit of the grayscale data. As shown in FIG. 6B, a channel region of the transistor Q(a+1)-b is formed by ion implantation so that the channel region is always in a conducting state. Therefore, the transistor Qa-b operates as a switch device, and the transistor Q(a+1)-b operates as a switch device which is always in an ON state.

This allows the data stored in the ROM to be changed only by mask replacement, and reduces the layout area.

3.2 This Embodiment

3.2.1 First Configuration Example

It is desirable that the grayscale voltage generation circuits 54 shown in FIGS. 4 and 5 generate different grayscale voltage groups in color component units. However, the layout area is increased when arranging the grayscale voltage generation circuits and the grayscale voltage signal line groups in a second direction which intersects the first direction, for example. In particular, the length in the second direction is increased in FIG. 5.

To deal with this problem, this embodiment uses a layout described below to provide a driver circuit which realizes two or more types of gamma correction without increasing the layout area.

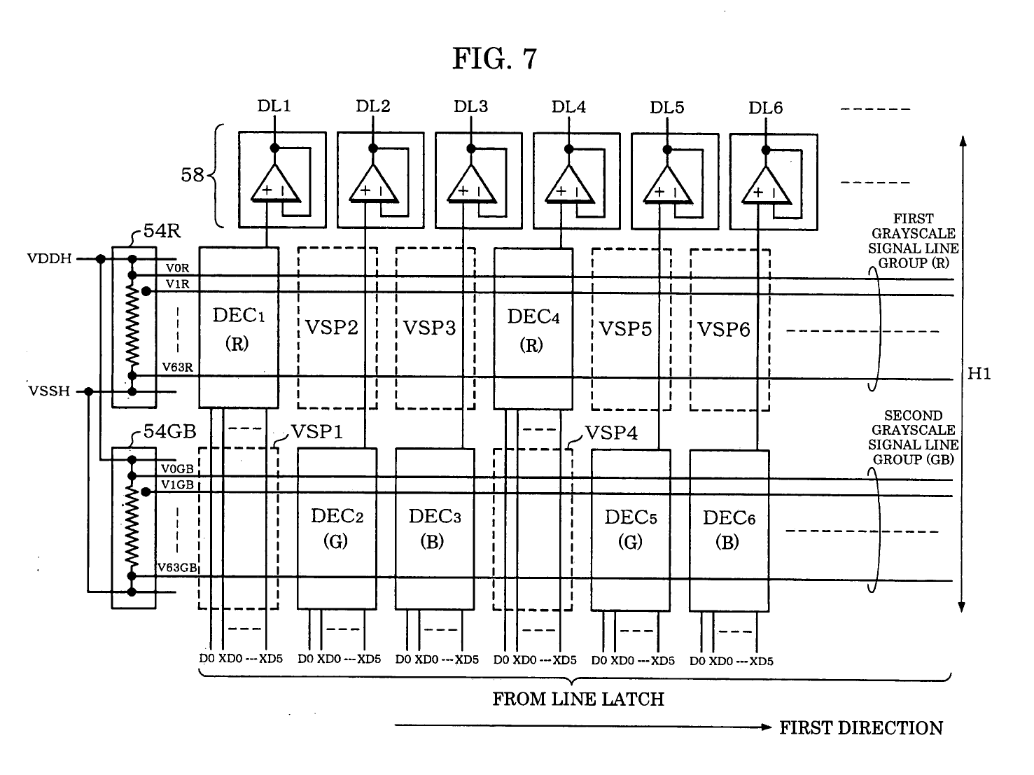

FIG. 7 is a block diagram of a configuration example of the grayscale voltage generation circuit 54, the DAC 56, and the driver section 58 according to this embodiment. In FIG. 7, the same sections as shown in FIG. 5 are indicated by the same symbols. Description of these sections is appropriately omitted.

When one pixel includes an R component, a G component, and a B component, the grayscale voltage generation circuit 54 shown in FIG. 7 includes a grayscale voltage generation circuit 54R for the R component and a grayscale voltage generation circuit 54GB for the G component and the B component. Specifically, grayscale voltages V0R to V63R generated by the grayscale voltage generation circuit 54R are supplied to a first grayscale signal line group. Grayscale voltages V0GB to V63GB generated by the grayscale voltage generation circuit 54GB are supplied to a second grayscale signal line group. Specifically, the grayscale voltages supplied to the second grayscale signal line group are used as the grayscale voltages for color components other than the first color component.

The dots of each pixel of the LCD panel 20 are arranged in the first direction in the order of “RGB”, “RGB”, . . . Therefore, the grayscale voltages V0R to V63R are supplied to the R component voltage select circuits DEC₁, DEC₄, DEC₇, . . . through the first grayscale signal line group. The grayscale voltages V0GB to V63GB are supplied to the G/B component voltage select circuits DEC₂, DEC₃, DEC₅, DEC₆, DEC₈, DEC₉, . . . through the second grayscale signal line group.

In the configuration shown in FIG. 7, space areas VSP1 to VSPN exist in which the voltage select circuit is not disposed. In the space area, a lower layer interconnect extends to which the grayscale data is supplied from the line latch 52, and an upper layer interconnect of the first or second grayscale signal line group is disposed. This makes it difficult to form another circuit in the space area, whereby the space area cannot be effectively utilized. Therefore, the length in a direction H1 shown in FIG. 7 is increased, whereby the layout area of the data driver 20 (driver circuit) is increased.

In this embodiment, the voltage select circuits are arranged in the first direction as described below so that the output circuit can be disposed in the space area, whereby the length in the direction H1 shown in FIG. 7 can be reduced.

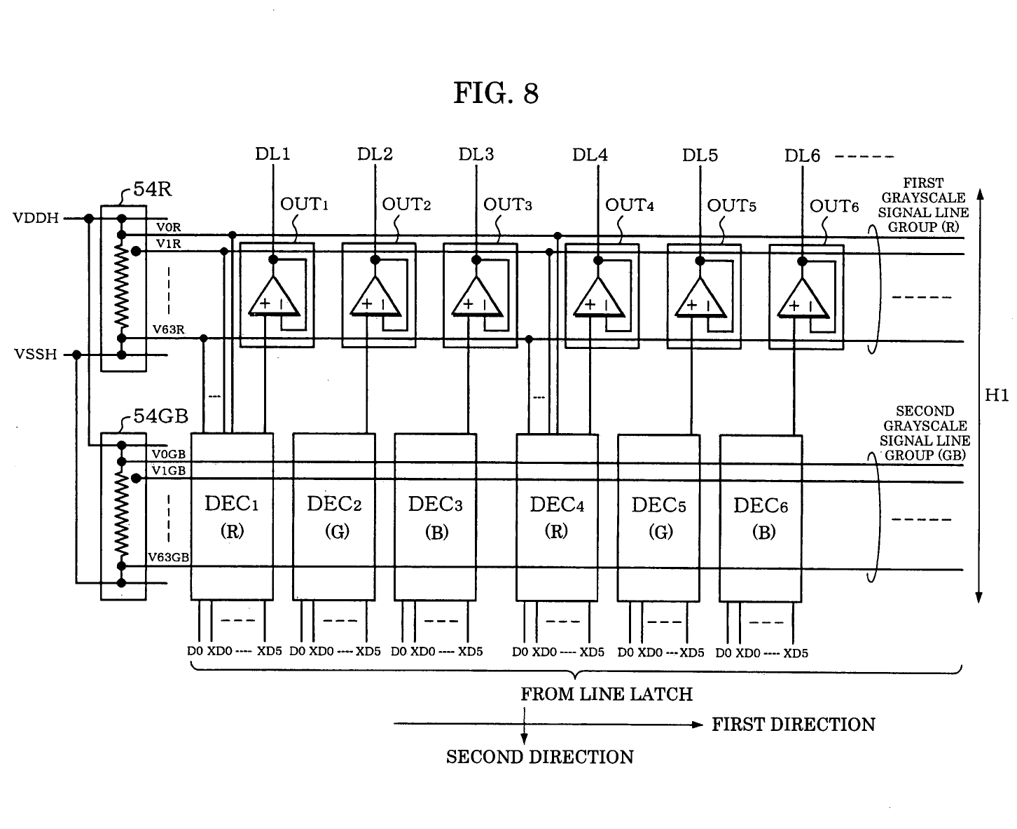

FIG. 8 is a block diagram of a configuration example of the grayscale voltage generation circuit 54, the DAC 56, and the driver section 58 according to a first configuration example of this embodiment. In FIG. 8, the same sections as shown in FIG. 7 are indicated by the same symbols. Description of these sections is appropriately omitted.

The voltage select circuit DEC₁ (first color component first voltage select circuit) outputs the grayscale voltage corresponding to first grayscale data from the grayscale voltages supplied to the grayscale signal lines of the first grayscale signal line group. The voltage select circuit DEC₂ (second color component second voltage select circuit) outputs the grayscale voltage corresponding to second grayscale data from the grayscale voltages supplied to the grayscale signal lines of the second grayscale signal line group.

The output circuit OUT₁ (first color component first output circuit) drives the data line DL1 based on the grayscale voltage output from the voltage select circuit DEC₁. The output circuit OUT₂ (second color component second output circuit) drives the data line DL2 based on the grayscale voltage output from the voltage select circuit DEC₂.

The voltage select circuits DEC₁ and DEC₂ are disposed to be adjacent in the first direction and provided in the upper layer or the lower layer of the second grayscale signal line group. In more detail, the voltage select circuits DEC₁ and DEC₂ are provided in the upper layer or the lower layer of the interconnect layer which forms the second grayscale signal line group through one or more insulating layers. The grayscale voltages V0R to V63R supplied to the first grayscale signal line group are supplied to the voltage select circuit DEC₁ through interconnects extending in the second direction which intersects the first direction. The grayscale voltages V0GB to V63GB supplied to the second grayscale signal line group are supplied to the voltage select circuit DEC₂ provided in the upper layer or the lower layer of the second grayscale signal line group through contacts.

The first direction may be referred to as the direction in which the data lines DL1 to DLN are arranged. The second direction may be referred to as the direction which intersects the direction in which the data lines DL1 to DLN are arranged. In more detail, the second direction may be referred to as the direction which intersects the direction in which the data lines DL1 to DLN are arranged and which extends from the end toward the center of the data driver 20.

It is preferable that the output circuits OUT₁ and OUT₂ (first and second output circuits) be provided in the upper layer or the lower layer of the first grayscale signal line group. In FIG. 8, since the lower layer interconnects through which the grayscale data is transmitted do not extend to the first grayscale signal line group from the line latch 52, differing from FIG. 7, the output circuit can be formed in the lower layer of the first grayscale signal line group, for example.

The first configuration example thus eliminates the space area shown in FIG. 7 to reduce the length in the direction H1 in FIG. 8.

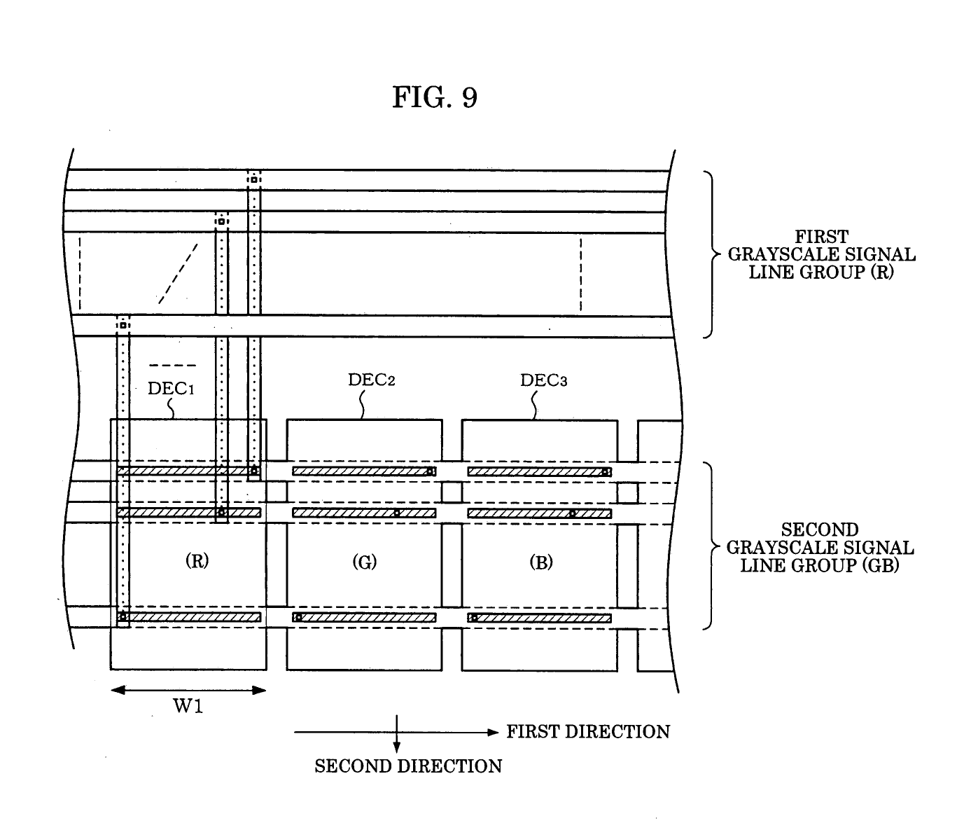

FIG. 9 schematically shows a layout plan view of FIG. 8.

In FIG. 9, the grayscale signal lines of the first and second grayscale signal line groups are formed by a third interconnect layer extending in the first direction. The grayscale signal lines of the first grayscale signal line group are connected with the voltage select circuit DEC₁ through a second interconnect layer provided in the lower layer of the third layer and extending in the second direction using contacts. The voltage select circuit DEC₁ is connected with a first interconnect layer in the lower layer of the second interconnect layer, and the grayscale voltages are supplied to the voltage select circuit DEC₁ through the first grayscale signal line group.

The grayscale signal lines of the second grayscale signal line group are connected with the voltage select circuits DEC₂ and DEC₃ through contacts. The grayscale voltages are supplied to the voltage select circuits DEC₂ and DEC₃ through the second grayscale signal line group.

In FIG. 9, the third interconnect layer is indicated by dotted lines inside the voltage select circuit for convenience of illustration.

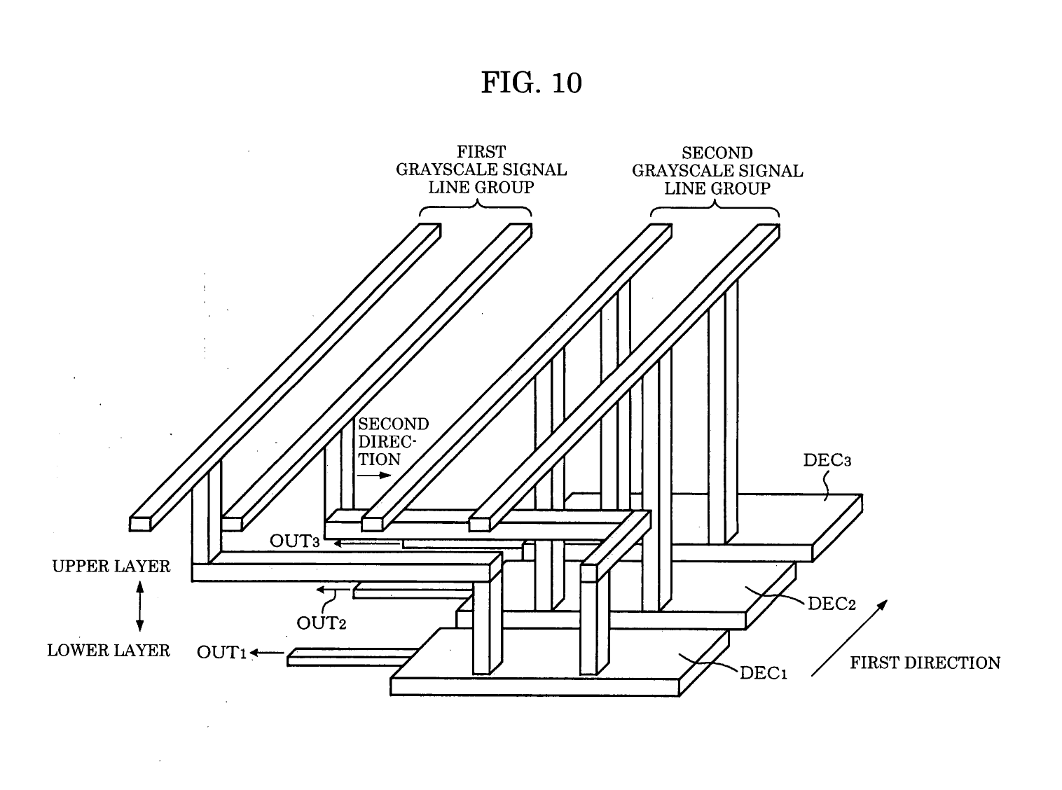

FIG. 10 is a diagram illustrative of the interconnect layers shown in FIG. 9.

When the first and second grayscale signal line groups are formed by the third interconnect layer, as shown in FIG. 10, the grayscale voltages are supplied to the voltage select circuit DEC₁ from the first grayscale signal line group formed by the third interconnect layer through the second interconnect layer extending in the second direction. The outputs of the voltage select circuits DEC₁ to DEC₃ are connected with the output circuits OUT₁ to OUT₃ through the first interconnect layer.

3.2.2 Second Configuration Example

In the first configuration example, when supplying the grayscale voltages supplied to the first grayscale signal line group to the voltage select circuit DEC₁ through the second interconnect layer extending in the second direction as shown in FIG. 9, it is desirable that the width of the interconnect region of the second interconnect layer be smaller than the width W1 of the voltage select circuit DEC₁ in the first direction. If the width of the interconnect region of the second interconnect layer is greater than the width W1 of the voltage select circuit DEC₁ in the first direction, it is necessary to bend the second interconnect layer, whereby the interconnect region is further increased.

However, the number of grayscale signal lines of the first grayscale signal line group increases as the number of grayscales increases, whereby it is difficult to reduce the width of the interconnect region of the second interconnect layer in comparison with the width W1 of the voltage select circuit DEC₁ in the first direction.

In a second configuration example of this embodiment, the R component voltage select circuits are disposed as described below.

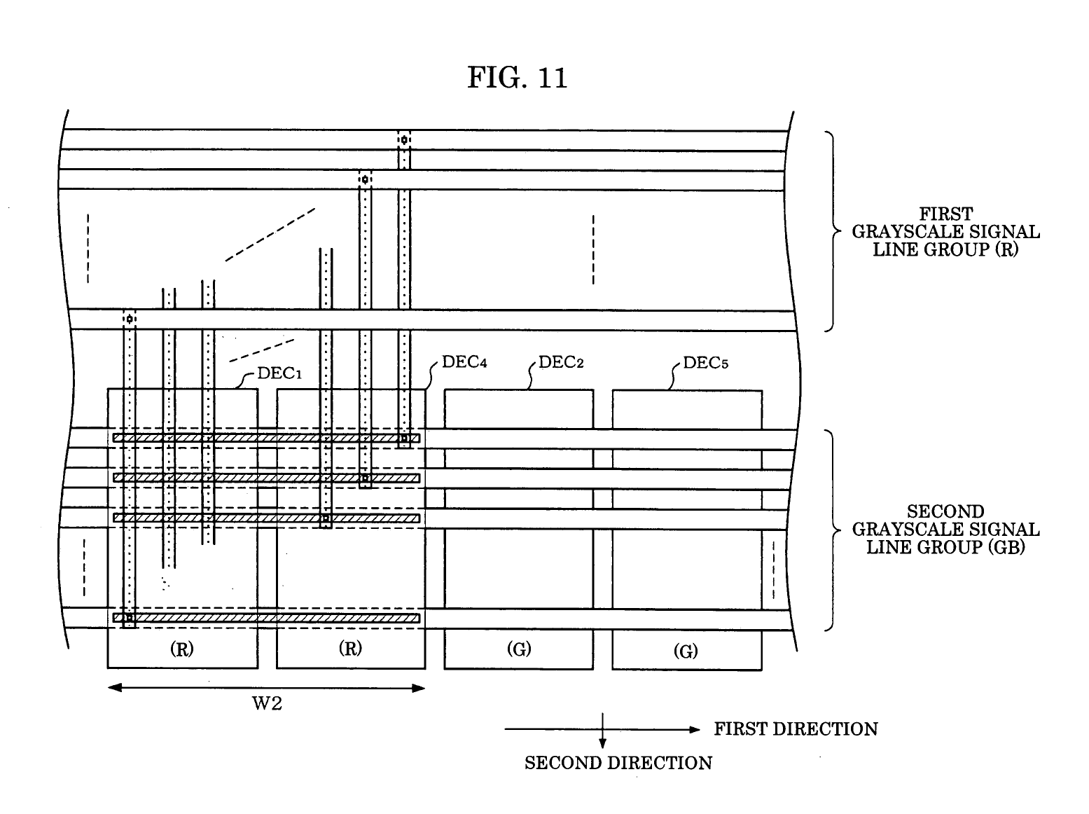

FIG. 11 schematically shows a layout plan view showing the relationship among the first and second grayscale signal line groups and the voltage select circuits according to the second configuration example of this embodiment. In FIG. 11, the same sections as shown in FIG. 9 are indicated by the same symbols. Description of these sections is appropriately omitted.

In the second configuration example, the R component voltage select circuits (first voltage select circuits) (e.g. voltage select circuits DEC₁ and DEC₄) are disposed to be adjacent in the first direction, and the second interconnect layer is used by the voltage select circuits (e.g. voltage select circuits DEC₁ and DEC₄). Specifically, the grayscale voltages supplied to the first grayscale signal line group are supplied to the voltage select circuits (e.g. voltage select circuits DEC₁ and DEC₄) through one interconnect group extending in the second direction. This allows an acceptable width W2 of the interconnect region of the second interconnect layer to be at least twice the width W1 in FIG. 9, whereby the interconnect region of the second interconnect layer can be substantially increased.

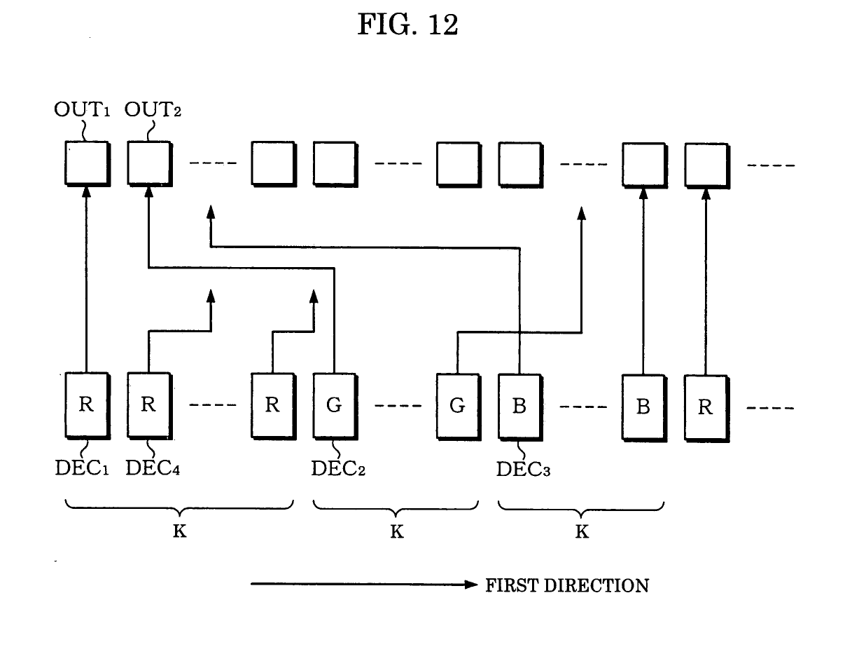

FIG. 12 shows the relationship among the voltage select circuits and the output circuits according to the second configuration example.

In FIG. 12, K (K is an integer of two or more) voltage select circuits for a single color component are disposed to be adjacent in the first direction. In the second configuration example, since the arrangement of the outputs from the voltage select circuits differs from the arrangement of the dots of the LCD panel 20, it is necessary to rearrange the outputs from the voltage select circuits using interconnects.

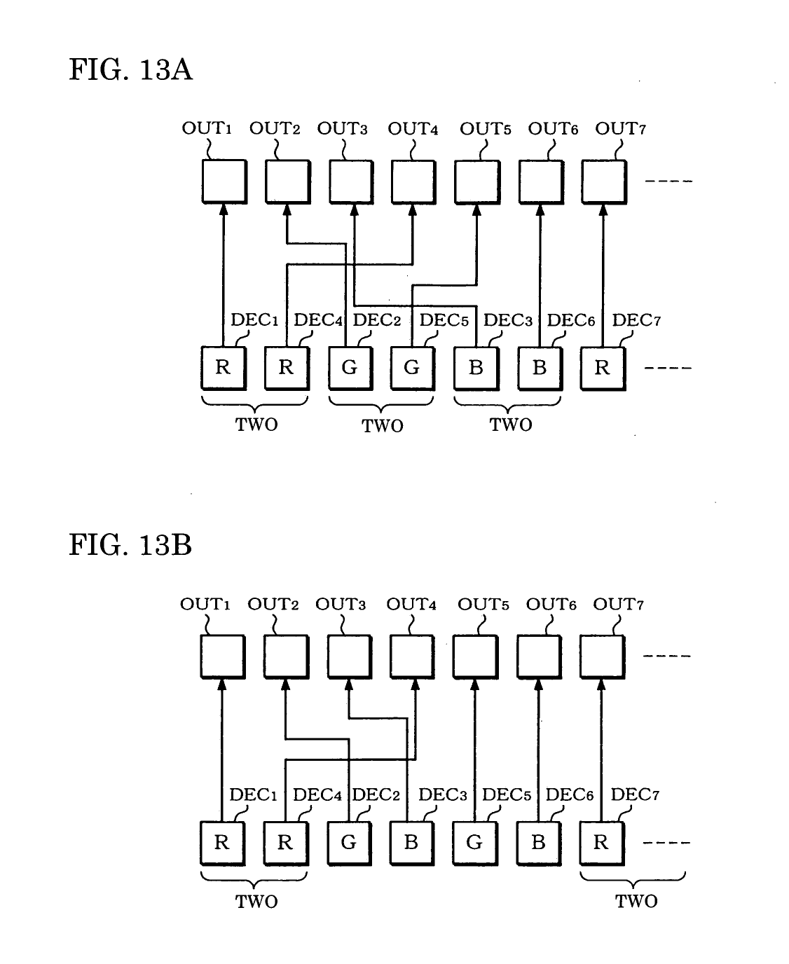

FIGS. 13A and 13B show the relationship among the voltage select circuits and the output circuits when K is “2”.

FIG. 13A shows the case where when K is “2” in FIG. 12. In FIG. 13B, only the R component voltage select circuits to which the grayscale voltages are supplied through the first grayscale signal line group are disposed to be adjacent to each other. In FIG. 13B, the number of interconnects which intersect can be reduced in comparison with FIG. 13A.

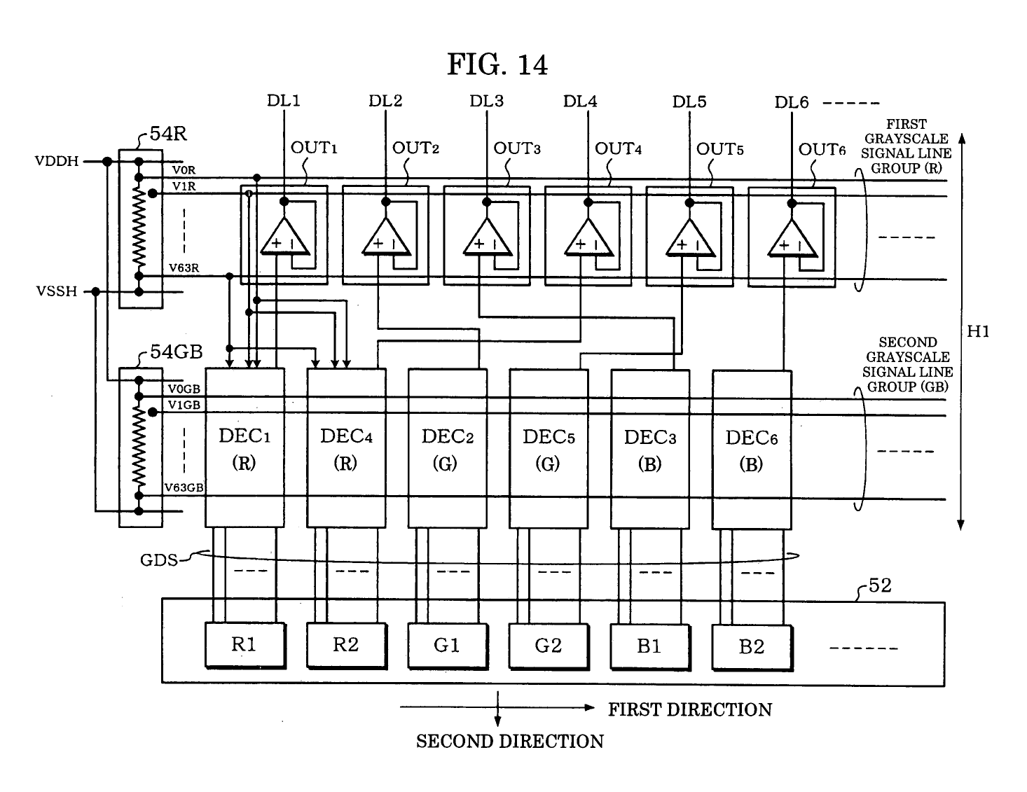

FIG. 14 is a block diagram of a configuration example of the grayscale voltage generation circuit 54, the DAC 56, and the driver section 58 according to the second configuration example of this embodiment. FIG. 14 shows a configuration example when K is “2”. In FIG. 14, the same sections as shown in FIG. 8 are indicated by the same symbols. Description of these sections is appropriately omitted. A similar configuration is also employed when K is three or more.

The R component voltage select circuits DEC₁ and DEC₄ (first color component first voltage select circuits) output the grayscale voltages corresponding to the grayscale data from the grayscale voltages supplied to the grayscale signal lines of the first grayscale signal line group. The G component voltage select circuit DEC₂ (second color component second voltage select circuit) outputs the grayscale voltage corresponding to the grayscale data from the grayscale voltages supplied to the grayscale signal lines of the second grayscale signal line group.

The R component output circuits OUT₁ and OUT₄ (first color component first output circuits) drive the data lines DL1 and DL4 based on the grayscale voltages output from the R component voltage select circuits DEC₁ and DEC₄ (first voltage select circuits). The G component output circuit OUT₂ (second color component second output circuit) drives the data lines DL2 based on the grayscale voltage output from the G component voltage select circuit DEC₂ (second color component second voltage select circuit).

The R component voltage select circuits DEC₁ and DEC₄ are disposed to be adjacent in the first direction. The G component voltage select circuit DEC₂ is disposed to be adjacent to the R component voltage select circuits DEC₁ and DEC₄ (first voltage select circuits) in the first direction. The R component voltage select circuits DEC₁ and DEC₄ and the G component voltage select circuit DEC₂ are provided in the upper layer or the lower layer of the second grayscale signal line group. The grayscale voltages supplied to the grayscale signal lines of the second grayscale signal line group are supplied to the R component voltage select circuits DEC₁ and DEC₄ (first voltage select circuits) through the interconnect group which extends in the second direction which intersects the first direction and is used by the R component voltage select circuits DEC₁ and DEC₄ (first voltage select circuits).

It is desirable that the grayscale data for each color component be held in the registers of the line latch 52 corresponding to the arrangement of the voltage select circuits in the first direction instead of the arrangement of the dots of the LCD panel. This makes it unnecessary to cross the interconnects for the outputs from the line latch 52. Specifically, the grayscale data corresponding to the voltage select circuits is held in the line latch 52 (grayscale data latch) in dot units. The grayscale data of each dot, which is supplied in pixel units in the order of a specific dot arrangement and rearranged in the order of the arrangement of the voltage select circuits arranged in the first direction, is held in the registers of the line latch 52. The grayscale data of each dot held in the line latch 52 is supplied to the voltage select circuits through grayscale data supply lines GDS provided not to intersect.

In FIG. 14, when the R component grayscale data R1, G component grayscale data G1, B component grayscale data B1, R component grayscale data R2, G component grayscale data G2, and B component grayscale data B2 are supplied to the data driver 30 in that order, the grayscale data is rearranged and written into the data latch 50, for example. Specifically, the data fetch control circuit 51 updates the address which designates the register in which the grayscale data for each color component is held in a specific sequence in synchronization with the dot clock signal DCLK. Therefore, the grayscale data for each color component is written into the register of the data latch 50 corresponding to the address designated by the data fetch control circuit 51, and is held in the line latch 52 in the arrangement shown in FIG. 14.

In FIG. 14, the G component voltage select circuit DEC₅ is disposed to be adjacent to the G component voltage select circuit DEC₂ in the first direction. Note that the B component voltage select circuit DEC₃ may be disposed to be adjacent to the G component voltage select circuit DEC₂ in the first direction, as shown in FIG. 13B.

As described above, the second configuration example prevents an increase in the interconnect region of the second interconnect layer, even if the width of the interconnect region of the second interconnect layer is increased.

3.2.3 Third Configuration Example

In the second configuration example, the arrangement of the grayscale data of each dot is changed by designating the address of the data latch 50 when writing the grayscale data of each dot into the data latch 50. In a third configuration example, the data driver includes a display memory 90 (grayscale data memory), and the arrangement of the grayscale data of each dot is changed when writing the grayscale data of each dot into memory cells of the display memory 90.

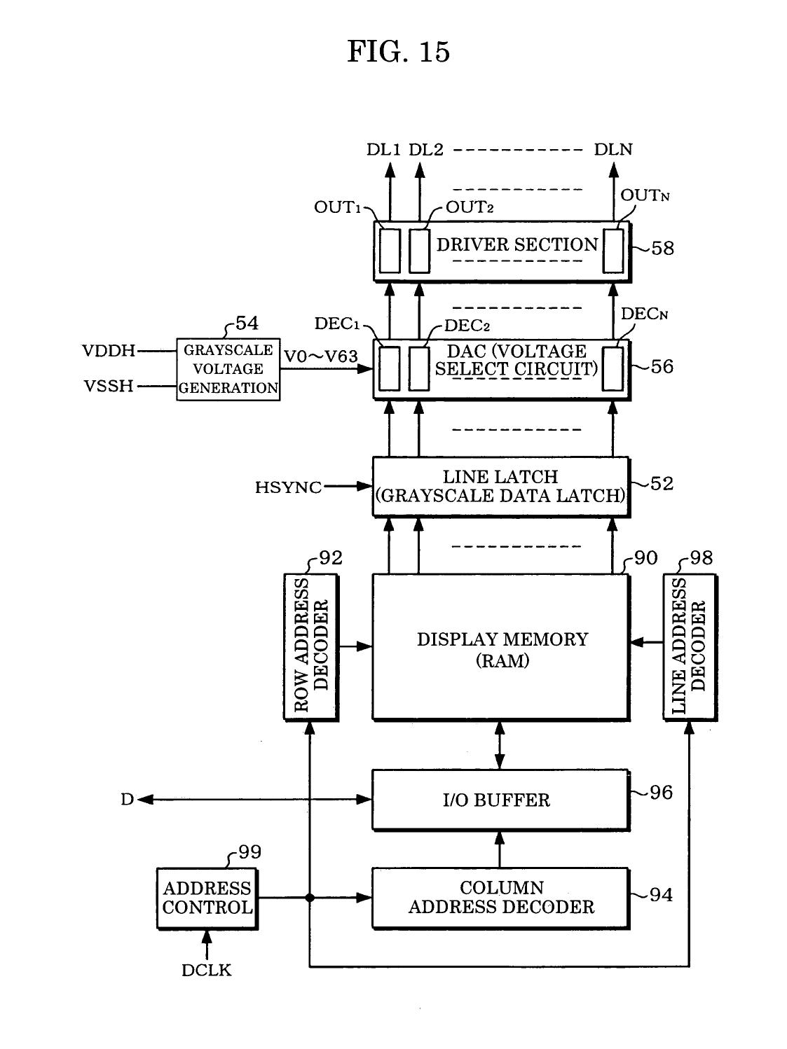

FIG. 15 is a block diagram of a data driver according to the third configuration example of this embodiment. In FIG. 5, the same sections as shown in FIG. 4 are indicated by the same symbols. Description of these sections is appropriately omitted.

The data driver according to the third configuration example differs from the data driver shown in FIG. 4 in that the data driver according to the third configuration example includes the display memory 90, a row address decoder 92, a column address decoder 94, an I/O buffer 96, a line address decoder 98, and an address control circuit 99 instead of the data latch 50 and the data fetch control circuit 51.

The display memory 90 (grayscale data memory) includes a plurality of memory cells provided corresponding to the voltage select circuits DEC₁ to DEC_{N}. Each memory cell is specified by a row address and a column address. The memory cells for one scan line are specified by a line address.

The I/O buffer 96 buffers the grayscale data written into the display memory 90 or the grayscale data read from the display memory 90. The I/O buffer 96 is accessed from the display controller 38 or the host (not shown).

The address control circuit 99 generates the row address, the column address, and the line address for specifying the memory cell in the display memory 90.

The address control circuit 99 generates the row address and the column address when writing the grayscale data into the display memory 90. Specifically, the grayscale data buffered by the I/O buffer 96 is written into the memory cell of the display memory 90 specified by the row address and the column address.

The row address decoder 92 decodes the row address and selects the memory cells of the display memory 90 corresponding to the row address. The column address decoder 94 decodes the column address and selects the memory cells of the display memory 90 corresponding to the column address. The line address decoder 98 decodes the line address and selects the memory cells of the display memory 90 corresponding to the line address.

The address control circuit 99 generates the line address when reading the grayscale data from the display memory 90 and outputting the grayscale data to the line latch 52. Specifically, the grayscale data for one horizontal scan read from the memory cells specified by the line address is output to the line latch 52.

The address control circuit 99 generates the row address and the column address when reading the grayscale data from the display memory 90 and outputting the grayscale data to the I/O buffer 96. Specifically, the grayscale data held in the memory cell of the display memory 90 specified by the row address and the column address is read into the I/O buffer 96. The grayscale data read into the I/O buffer 96 is read from the display controller 38 or the host (not shown).

Therefore, the row address decoder 92, the column address decoder 94, and the address control circuit 99 shown in FIG. 15 function as a write control circuit which controls writing of the grayscale data into the display memory 90. Specifically, the row address decoder 92, the column address decoder 94, and the address control circuit 99 designate the addresses of the memory cells corresponding to the arrangement of the voltage select circuits DEC₁ to DEC_{N} arranged in the first direction, and write the grayscale data of each dot supplied in pixel units in the order of a specific dot arrangement into the memory cells corresponding to the addresses.

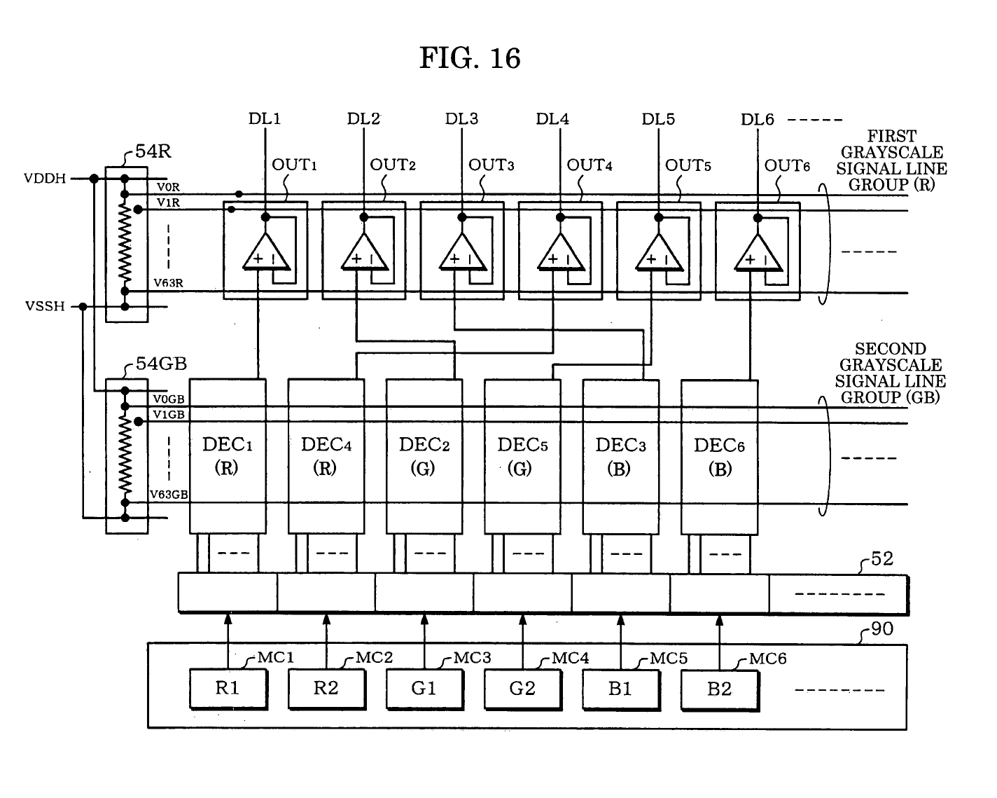

FIG. 16 is a block diagram of a configuration example of the grayscale voltage generation circuit 54, the DAC 56, and the driver section 58 according to the third configuration example of this embodiment. In FIG. 16, the same sections as shown in FIG. 14 are indicated by the same symbols. Description of these sections is appropriately omitted.

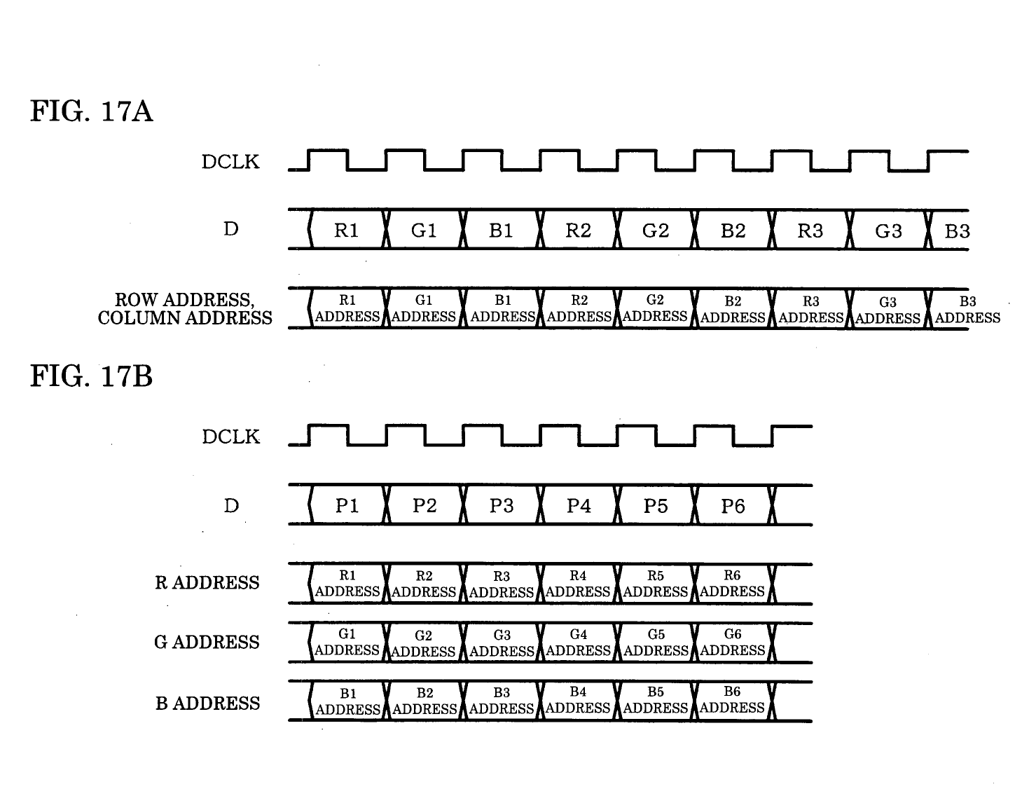

FIGS. 17A and 17B are timing diagrams of operation examples of the address control circuit 99 shown in FIG. 15.

FIG. 17A shows an example in which the grayscale data for each color component is supplied in dot units in synchronization with the dot clock signal DCLK and the address control circuit 99 updates the row address and the column address of the display memory 90 in synchronization with the dot clock signal DCLK.

FIG. 17B shows an example in which the grayscale data for one pixel is supplied in synchronization with the dot clock signal DCLK and the address control circuit 99 updates the row address and the column address which specify the memory cell of the display memory 90 in which the grayscale data for each color component is held in synchronization with the dot clock signal DCLK.

As shown in FIG. 16, when the R component grayscale data R1, G component grayscale data G1, B component grayscale data B1, R component grayscale data R2, G component grayscale data G2, and B component grayscale data B2 are supplied to the data driver 30 in that order, the grayscale data is rearranged and written into the data latch 50. In this case, the address control circuit 99 updates the row address and the column address which specify the memory cells MC1 to MC6 in which the grayscale data for each color component of one dot is held in a specific sequence in synchronization with the dot clock signal DCLK. Therefore, the grayscale data for each color component is written into the memory cell of the display memory 90 specified by the address designated by the address control circuit 99. When the line address has been designated by the address control circuit 99, the grayscale data for each color component arranged as shown in FIG. 16 is read into the line latch 52.

As described above, the third configuration example also allows the grayscale data of each dot held in the line latch 52 to be supplied to the voltage select circuits through the grayscale data supply lines GDS provided not to intersect.

3.2.4 Fourth Configuration Example

When providing the output circuits in the upper layer or the lower layer of the first grayscale signal line group, as shown in FIG. 8, the length in the direction H1 in FIG. 8 is reduced, whereby gamma correction may be performed in color component units. In this case, it is also desirable to reduce the layout area.

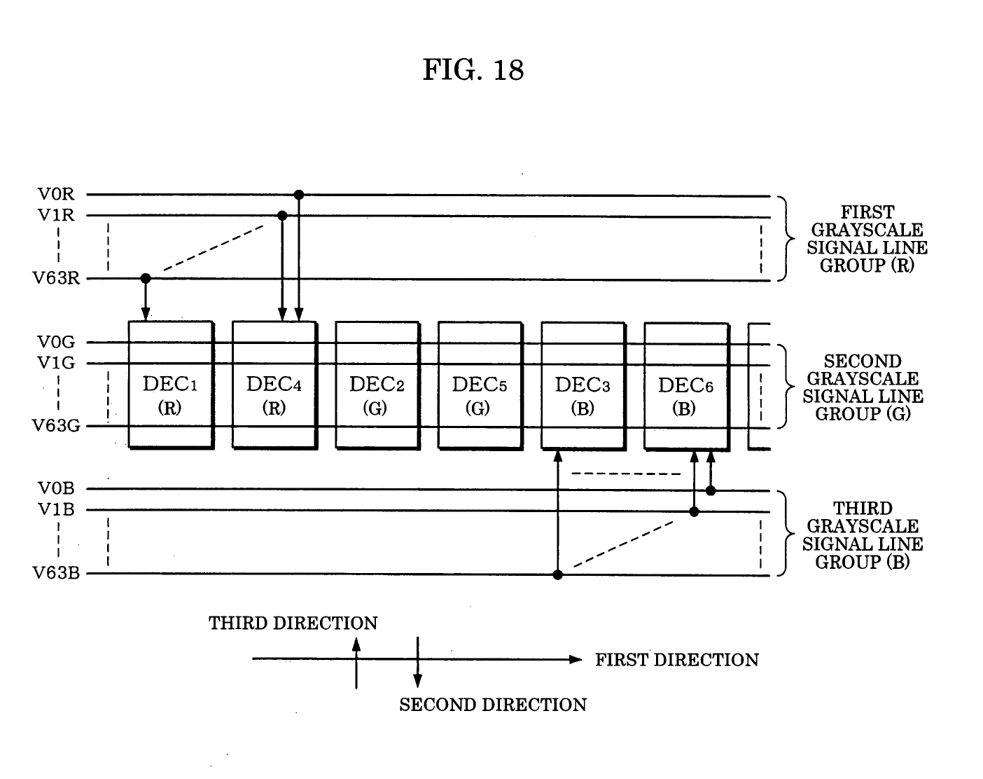

FIG. 18 shows the relationship among the voltage select circuits of the DAC 56 and the grayscale signal line groups according to a fourth configuration example of this embodiment.

In the fourth configuration example, gamma correction is performed for each of the R component, the G component, and the B component. The fourth configuration example further includes, in addition to the elements of the first configuration example shown in FIG. 8, a B component (third color component) third grayscale signal line group extending in the first direction and including grayscale signal lines to which the grayscale voltages corresponding to the grayscale data is supplied, a B component (third color component) third voltage select circuit which outputs the grayscale voltage corresponding to the grayscale data from the grayscale voltages supplied to the third grayscale signal line group, and a third color component third output circuit which drives the data line based on the grayscale voltage output from the third voltage select circuit.

The third voltage select circuit is disposed to be adjacent to the first voltage select circuit or the second voltage select circuit in the first direction and provided in the upper layer or the lower layer of the second grayscale signal line group. In FIG. 18, the B component voltage select circuit DEC₃ is disposed to be adjacent to the voltage select circuit DEC₅ in the first direction.

The grayscale voltages supplied to the third grayscale signal line group are supplied to the third voltage select circuit through interconnects extending in a third direction opposite to the second direction.

In this case, limitations to the interconnect layer are eliminated in comparison with the case of providing the third grayscale signal line group in the upper layer or the lower layer of the first grayscale signal line group. Moreover, gamma correction in color component units can be realized without increasing the layout area.

In FIG. 18, the B component third voltage select circuits DEC₃ and DEC₆ are disposed to be adjacent in the first direction. Note that only the B component third voltage select circuit DEC₃ may be disposed to be adjacent to the G component second voltage select circuit DEC₂ in the first direction in the same manner as in the first configuration example.

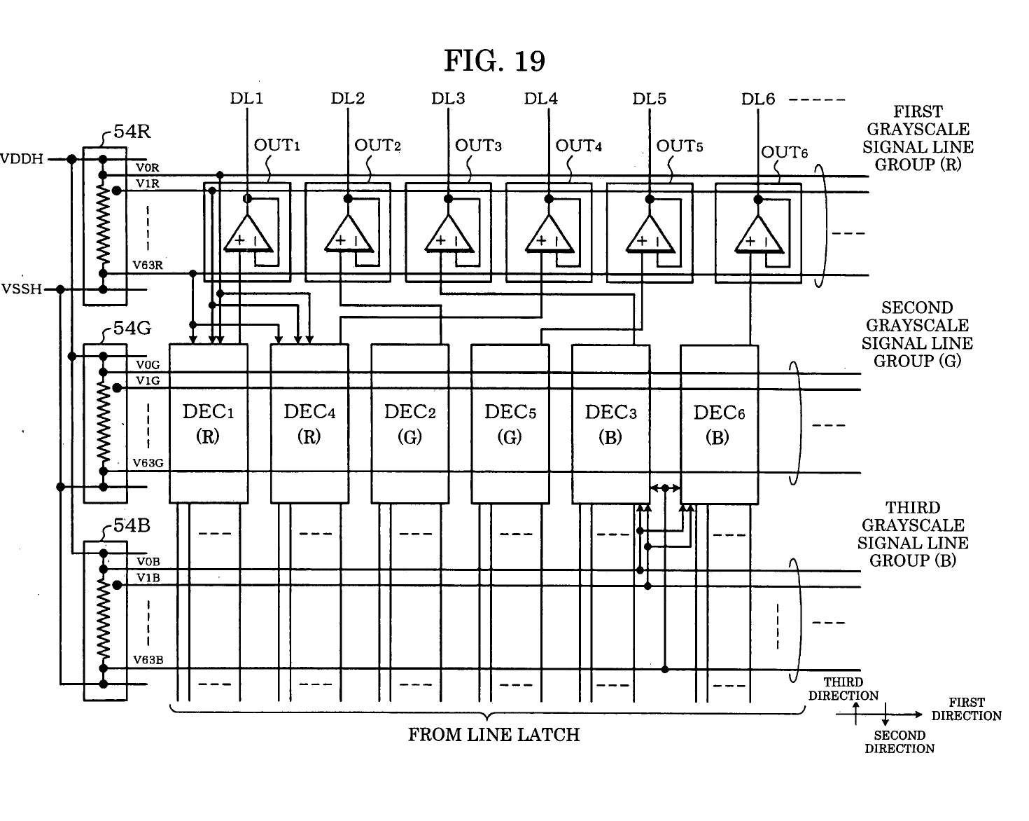

FIG. 19 is a block diagram of a configuration example of the grayscale voltage generation circuit 54, the DAC 56, and the driver section 58 according to the fourth configuration example of this embodiment. In FIG. 19, the same sections as shown in FIG. 14 are indicated by the same symbols. Description of these sections is appropriately omitted.

FIG. 19 differs from FIG. 14 in that the G component grayscale voltages V0G to V63G are supplied to the second grayscale signal line group and the B component grayscale voltages V0B to V63B are supplied to the third grayscale signal line group. Therefore, the grayscale voltages V0R to V63R are supplied to the R component voltage select circuit through the first grayscale signal line group, the grayscale voltages V0G to V63G are supplied to the G component voltage select circuit through the second grayscale signal line group, and the grayscale voltages V0B to V63B are supplied to the B component voltage select circuit through the third grayscale signal line group.

The voltage select circuits for each color component are arranged in the upper layer or the lower layer of the second grayscale signal line group, the grayscale voltages are supplied to the R component voltage select circuit in the second direction, and the grayscale voltages are supplied to the B component voltage select circuit in the third direction. This realizes gamma correction in color component units while preventing an increase in the layout area of the data driver.

4. Electronic Instrument

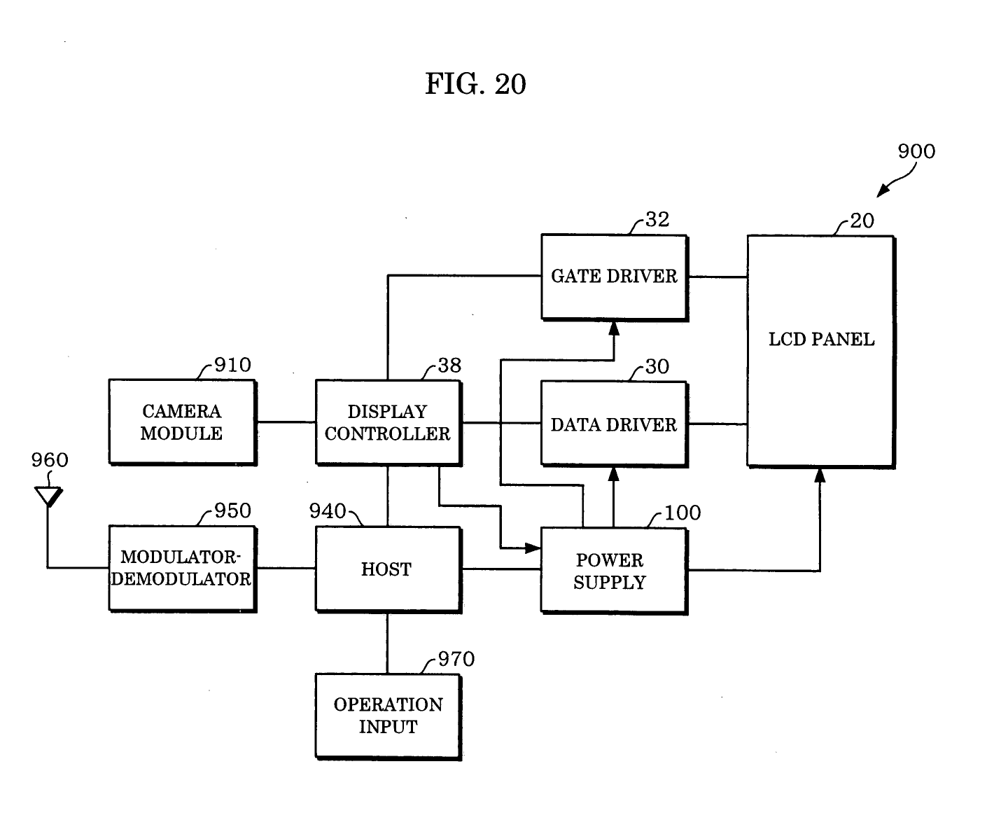

FIG. 20 is a block diagram of a configuration example of an electronic instrument according to one embodiment of the invention. FIG. 20 shows a block diagram of a configuration example of a portable telephone as an example of the electronic instrument. In FIG. 20, the same sections as shown in FIG. 1 or 2 are indicated by the same symbols. Description of these sections is appropriately omitted.

A portable telephone 900 includes a camera module 910. The camera module 910 includes a CCD camera, and supplies data of an image captured using the CCD camera to the display controller 38 in a YUV format.

The portable telephone 900 includes the LCD panel 20. The LCD panel 20 is driven by the data driver 30 and the gate driver 32. The LCD panel 20 includes a plurality of gate lines, a plurality of data lines, and a plurality of pixels.

The display controller 38 is connected with the data driver 30 and the gate driver 32, and supplies grayscale data in an RGB format to the data driver 30.

The power supply circuit 100 is connected with the data driver 30 and the gate driver 32, and supplies drive power supply voltages to the data driver 30 and the gate driver 32. The power supply circuit 100 supplies the common electrode voltage Vcom to the common electrode of the LCD panel 20.

A host 940 is connected with the display controller 38. The host 940 controls the display controller 38. The host 940 demodulates grayscale data received through an antenna 960 using a modulator-demodulator section 950, and supplies the demodulated grayscale data to the display controller 38. The display controller 38 causes the data driver 30 and the gate driver 32 to display an image on the LCD panel 20 based on the grayscale data.

The host 940 modulates grayscale data generated by the camera module 910 using the modulator-demodulator section 950, and directs transmission of the modulated data to another communication device through the antenna 960.

The host 940 transmits and receives grayscale data, captures an image using the camera module 910, and displays an image on the LCD panel 20 based on operation information from an operation input section 970.

The invention is not limited to the above-described embodiments. Various modifications and variations may be made within the spirit and scope of the invention. For example, the invention may be applied not only to drive the above-described liquid crystal display panel, but also to drive an electroluminescent or plasma display device.

Some of the requirements of any claim of the invention may be omitted from a dependent claim which depends on that claim. Moreover, some of the requirements of any independent claim of the invention may be allowed to depend on any other independent claim.

Although only some embodiments of the invention are described in detail above, those skilled in the art would readily appreciate that many modifications are possible in the embodiments without materially departing from the novel teachings and advantages of the invention. Accordingly, such modifications are intended to be included within the scope of the invention.

What is claimed is:

1. A driver circuit for driving data lines of an electro-optical device, the driver circuit comprising:
a first color component first grayscale signal line group and a second color component second grayscale signal line group, each of the first grayscale signal line group and the second grayscale signal line group extending in a first direction and including grayscale signal lines to which grayscale voltages corresponding to grayscale data are supplied;
a first voltage select circuit which outputs the grayscale voltage corresponding to first grayscale data from the grayscale voltages supplied to the grayscale signal lines of the first grayscale signal line group;
a second voltage select circuit which outputs the grayscale voltage corresponding to second grayscale data from the grayscale voltages supplied to the grayscale signal lines of the second grayscale signal line group; and
first and second output circuits which drive the data lines based on the grayscale voltages output from the first and second voltage select circuits;
the first and second voltage select circuits being disposed to be adjacent in the first direction in an upper layer or a lower layer of the second grayscale signal line group; and
the grayscale voltages supplied to the first grayscale signal line group being supplied to the first voltage select circuit through a plurality of interconnects extending in a second direction which intersects the first direction.

2. The driver circuit as defined in claim 1, wherein the first and second output circuits are provided in an upper layer or a lower layer of the first grayscale signal line group.

3. A driver circuit for driving data lines of an electro-optical device, the driver circuit comprising:
a first color component first grayscale signal line group and a second color component second grayscale signal line group, each of the first grayscale signal line group and the second grayscale signal line group extending in a first direction and including grayscale signal lines to which grayscale voltages corresponding to grayscale data are supplied;
a plurality of first voltage select circuits, each of the first voltage select circuits outputting the grayscale voltage corresponding to the grayscale data from the grayscale voltages supplied to the grayscale signal lines of the first grayscale signal line group;
a second voltage select circuit which outputs the grayscale voltage corresponding to the grayscale data from the grayscale voltages supplied to the grayscale signal lines of the second grayscale signal line group;
a plurality of first output circuits which drive the data lines based on the grayscale voltages output from the first voltage select circuits; and
a second output circuit which drives the data line based on the grayscale voltage output from the second voltage select circuit;
the first voltage select circuits being disposed to be adjacent in the first direction;
the second voltage select circuit being disposed to be adjacent to the first voltage select circuits in the first direction;
the first voltage select circuits and the second voltage select circuit being provided in an upper layer or a lower layer of the second grayscale signal line group; and
the grayscale voltages supplied to the first grayscale signal line group being supplied to the first voltage select circuits through a plurality of interconnects extending in a second direction which intersects the first direction and used by the first voltage select circuits.

4. The driver circuit as defined in claim 1, wherein the grayscale voltages supplied to the second grayscale signal line group are used as grayscale voltages for two or more color components other than the first color component.

5. The driver circuit as defined in claim 3, wherein the grayscale voltages supplied to the second grayscale signal line group are used as grayscale voltages for two or more color components other than the first color component.

6. The driver circuit as defined in claim 3, comprising:
a third color component third grayscale signal line group extending in the first direction and including grayscale signal lines to which the grayscale voltages corresponding to the grayscale data are supplied;
a third voltage select circuit which outputs the grayscale voltage corresponding to the grayscale data from the grayscale voltages supplied to the grayscale signal lines of the third grayscale signal line group; and
a third output circuit which drives the data line based on the grayscale voltage output from the third voltage select circuit;
wherein the third voltage select circuit is disposed to be adjacent to the first voltage select circuits or the second voltage select circuit in the first direction in the upper layer or the lower layer of the second grayscale signal line group; and
wherein the grayscale voltages supplied to the third grayscale signal line group are supplied to the third voltage select circuit through a plurality of interconnects extending in a third direction opposite to the second direction.

7. The driver circuit as defined in claim 6, wherein the first to third output circuits are provided in an upper layer or a lower layer of the first grayscale signal line group.

8. The driver circuit as defined in claim 3, comprising:
a grayscale data latch in which the grayscale data corresponding to each of the voltage select circuits is held in dot units;
wherein the grayscale data of each dot, which is supplied in pixel units in an order of a specific dot arrangement and rearranged in an order of an arrangement of the voltage select circuits arranged in the first direction, is held in the grayscale data latch; and
wherein the grayscale data of each dot held in the grayscale data latch is supplied to each of the voltage select circuits through grayscale data supply lines provided not to intersect.

9. The driver circuit as defined in claim 3, comprising:
a grayscale data memory including a plurality of memory cells provided corresponding to the voltage select circuits;
wherein the grayscale data of each dot, which is supplied in pixel units in an order of a specific dot arrangement and rearranged in an order of an arrangement of the voltage select circuits arranged in the first direction, is held in each of the memory cells.

10. The driver circuit as defined in claim 9, comprising:
a write control circuit which controls writing of the grayscale data into the grayscale data memory;
wherein the write control circuit designates addresses of the memory cells corresponding to the arrangement of the voltage select circuits arranged in the first direction, and writes the grayscale data of each dot supplied in pixel units in the order of the specific dot arrangement into the memory cells corresponding to the addresses.

11. An electro-optical device comprising:
a plurality of scan lines;
a plurality of data lines;
a plurality of pixels;
a scan line driver circuit which scans the scan lines; and
the driver circuit as defined in claim 1 which drives the data lines.

12. An electro-optical device comprising:
a plurality of scan lines;
a plurality of data lines;
a plurality of pixels;
a scan line driver circuit which scans the scan lines; and
the driver circuit as defined in claim 3 which drives the data lines.

13. An electronic instrument comprising the electro-optical device as defined in claim 11.

14. An electronic instrument comprising the electro-optical device as defined in claim 12.
